(19) United States
(12) Patent Application Publication
(10) Pub. No.: US 2025/0245746 A1
(43) Pub. Date: Jul. 31, 2025

(54) Systems and Methods for Managing Retirement Benefits with Non-Fungible Tokens

(71) Applicant: TEACHERS INSURANCE AND ANNUITY ASSOCIATION OF AMERICA, New York, NY (US)

(72) Inventors: Sastry Vsm Durvasula, Phoenix, AZ (US); Swatee Singh, Livingston, NJ (US); Rares Ioan Almasan, Paradise Valley, AZ (US); Vamsi Pola, Concord, NC (US)

(21) Appl. No.: 18/429,206

(22) Filed: Jan. 31, 2024

(51) Int. Cl. G06Q 40/06

(52) U.S. Cl. CPC G06Q 40/06

(57) ABSTRACT

A computer system for generating and facilitating the exchange of non-fungible tokens, the system comprising one or more processors; and one or more memories having stored thereon instructions that, when executed cause the one or more processors to identify one or more retirement assets associated with a user, receive beneficiary data associated with the one or more retirement assets from the user, the beneficiary data including an asset distribution scheme, retrieve data associated with the one or more assets from one or more financial institutions via an application programming interface, mint one or more tokens representing the one or more retirement assets and beneficiary data associated with the one or more retirement assets, receive a notification of a distribution event associated with the one or more retirement assets, automatically verify the notification of the distribution event, and automatically distribute one or more retirement assets via one or more smart contracts.

### TECHNICAL FIELD

The present disclosure is generally directed to methods and systems for managing retirement benefits with non-fungible tokens (NFTs).

### BACKGROUND

Traditional retirement account management systems involve complex paperwork and administrative processes that can be difficult to navigate. When an account holder (i.e., a user) dies, a financial institution receives a notification of death. The financial institution must verify the death of the account holder, identify one or more beneficiaries of the account holder's assets, and distribute the account holder's assets.

The distribution process may be time-consuming and complicated. The distribution process may involve the use of multiple systems. For example, a retiree account holder may have multiple assets spread across multiple locations, as well as multiple beneficiaries with differing interests for each asset. A retirement financial institution may process tens of thousands of beneficiary settlements a year and can take up to 90 days to process each claim. Moreover, conventional verification work must be done manually. While some processes may be automated, such as inheritance calculations, other processes are not and may be more difficult to automate. The complexity and volume of the administrative work in managing the account and distributing the assets may lead to errors, and disputes in addition to the delay associated with conventional distribution activity. Furthermore, there may be a lack of transparency and security during this process.

Additionally, records of the asset may be susceptible to inaccuracies. The financial institution at which the account holder has an account maintains records for each asset at? that financial institution. However, because the financial institution acts as the sole record-keeper, account information such as position and balances may not be accurate. For example, the financial institution may incorrectly record a transaction, or fail to record it at all. Additionally, the account may be vulnerable to illegal alterations.

Thus, there is an opportunity for a unified digital system that streamlines the setup, management, and distribution of a user's retirement assets.

### BRIEF SUMMARY

In one aspect, a computer system for generating and facilitating the exchange of non-fungible tokens, the system comprising: one or more processors; and one or more memories having stored thereon instructions that, when executed cause the one or more processors to (1) identify one or more assets associated with a user; (2) receive beneficiary data associated with the one or more assets from the user, the beneficiary data including an asset distribution scheme; (3) retrieve data associated with the one or more assets from one or more financial institutions via an application programming interface; (4) mint one or more tokens representing the one or more retirement assets and beneficiary data associated with the one or more retirement assets, the asset distribution scheme encoded as one or more smart contracts; (5) receive a notification of death of the user; (6) automatically verify the notification of death; and (7) automatically distribute one or more retirement assets to one or more beneficiaries via the one or more smart contracts.

In another aspect, a computer-implemented method for generating and facilitating the exchange of non-fungible tokens, the method comprising (1) identifying, via the one or more processors, one or more assets associated with a user; (2) receiving, via the one or more processors, beneficiary data associated with the one or more assets from the user, the beneficiary data including an asset distribution scheme; (3) retrieving, via the one or more processors, data associated with the one or more assets from one or more financial institutions via an application programming interface; (4) minting, via the one or more processors, one or more tokens representing the one or more retirement assets and beneficiary data associated with the one or more retirement assets, the asset distribution scheme encoded as one or more smart contracts; (5) receiving, via the one or more processors, a notification of death of the user; (6) automatically verifying, via the one or more processors, the notification of death; and (7) automatically distributing, via the one or more processors, one or more retirement assets to one or more beneficiaries via the one or more smart contracts.

In yet another aspect, a non-transitory computer readable medium containing program instructions that when executed, cause one or more processors to (1) identify one or more assets associated with a user; (2) receive beneficiary data associated with the one or more assets from the user, the beneficiary data including an asset distribution scheme; (3) retrieve data associated with the one or more assets from one or more financial institutions via an application programming interface; (4) mint one or more tokens representing the one or more retirement assets and beneficiary data associated with the one or more retirement assets, the asset distribution scheme encoded as one or more smart contracts; (5) receive a notification of death of the user; (6) automatically verify the notification of death; and (7) automatically distribute one or more retirement assets to one or more beneficiaries via the one or more smart contracts.

### BRIEF DESCRIPTION OF THE FIGURES

The figures described below depict various aspects of the system and methods disclosed therein. It should be understood that each figure depicts one embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an exemplary computing environment for managing retirement benefits with non-fungible tokens, according to some aspects.

FIG. 2 depicts exemplary nodes and an exemplary distributed ledger, according to some aspects.

FIG. 3 depicts an exemplary transaction flow, according to some aspects.

FIG. 4 depicts an example combined block and flow diagram of a system for tokenizing retirement assets, according to some aspects.

FIG. 5 depicts an example user interface of an application allowing a user to view and manage a retirement account, according to some aspects.

FIG. 6 is a flow diagram of an example method for managing retirement benefits with non-fungible tokens, according to some aspects.

### DETAILED DESCRIPTION

### Overview

The present techniques are directed to generating and facilitating the exchange of non-fungible tokens with non-fungible tokens (NFTs), generating recommendations for allocation and management of retirement assets using machine learning (ML) and artificial intelligence (AI), and classification of retirement assets using ML and AI. In some aspects, a retirement financial institution computing system may include one or more processors and a memory for storing instructions for managing retirement benefits. The retirement financial institution computing system may identify one or more retirement assets associated with a user, receive beneficiary data, including how the assets are to be distributed among beneficiaries, associated with the one or more retirement assets from the user, and retrieve associated with the one or more assets from one or more financial institutions via an application programming interface. This information may be recorded on a distributed ledger by generating an NFT by creating an NFT containing the retirement asset data and recording it on a distributed ledger. Upon notification of a distribution event, a smart contracts execute to distribute assets to receiving parties. For example, when the account holder (i.e., user) dies, the retirement financial institution computing system may receive a notification of the death of the user (e.g., via a claim from a beneficiary, via public records, etc.). The retirement financial computing system may then verify the notification of death to determine that the user is actually deceased. When the notification of death has been verified, smart contracts automatically execute to distribute the retirement assets to beneficiaries according to the distribution scheme.

The conventional techniques for managing benefits and processing claims may be inefficient. A retiree may have multiple accounts at different financial institutions, leading to difficulties in keeping track of all of the retiree's assets. The retiree may designate multiple beneficiaries of assets, complicating the calculation of shares and distribution to the beneficiaries. Additionally, the retiree may be unaware that a particular asset does not have a designated beneficiary, or of the best way to apportion assets to best meet the retiree's needs and wants. After the retiree has passed, there may be difficulties in ascertaining the totality of the retiree's estate, as well as tracking down beneficiaries. Moreover, many of the verifications, calculations, and distributions to beneficiaries after the retiree's death are currently done manually and may be time consuming for a retirement financial institution. The process may also be confusing for beneficiaries to navigate, leading to delays, errors, and/or disputes.

Managing retirement benefits with non-fungible tokens improve the process of managing benefits and processing claims. Utilizing blockchain technology to record account activity ensures reliability and security of record keeping, as blockchain technology includes a distributed ledger that is immutable and auditable. Smart contracts allow the assets to be automatically distributed to beneficiaries according to the retiree's wishes, simplifying and expediting distribution of the retiree's assets after death. Artificial intelligence (AI) and machine learning (ML) technologies also improve management of the account (e.g., by offering suggestions for investment and distribution).

### Exemplary Computing Environment

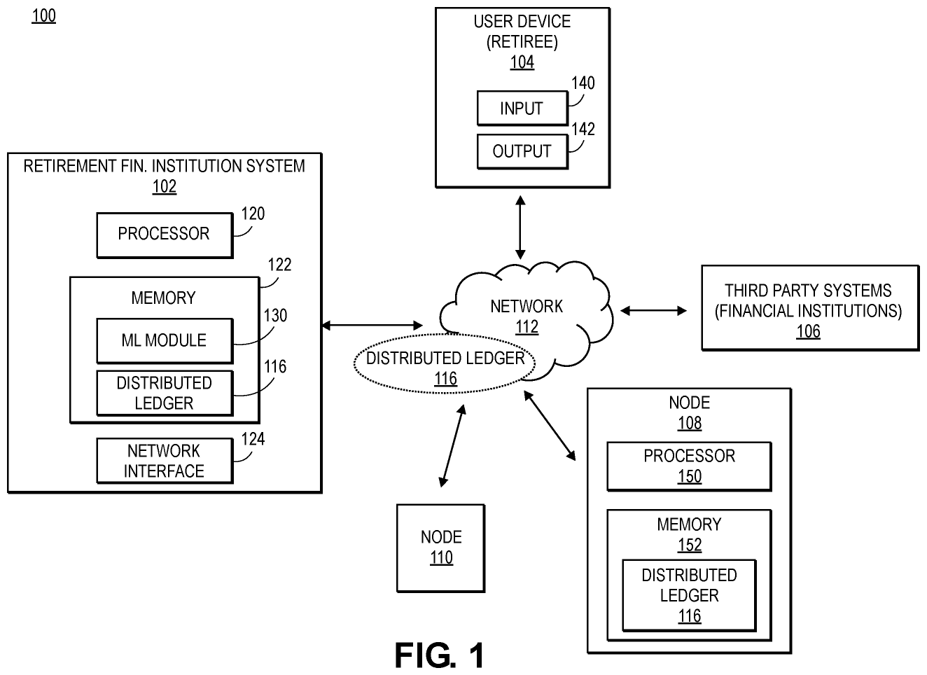

FIG. 1 depicts an exemplary computing environment 100 in which techniques for managing retirement benefits with non-fungible tokens (NFTs) may be implemented, according to some aspects. Example computing environment 100 may include more or fewer components than what is shown.

The environment 100 may include a retirement financial institution computing system 102, a user device 104, a third-party financial institution computing system 106, a node 108, a node 110, a network 112, and a distributed ledger 116. The retirement financial institution computing system 102, user device 104, third-party financial institution computing system 106, and the nodes 108 and 110 may all be communicatively coupled via network 112. One or more components of the retirement financial institution computing system 100 may be provided by virtual instances (e.g., one or more cloud-based virtualization services).

The retirement financial institution computing system 102 may be associated with (e.g., owned/operated by) a company that sells financial, etc. products and/or services. The retirement financial institution computing system 102 may be an individual server, a group (e.g., cluster) of multiple servers, or another suitable type of computing device or system (e.g., a collection of cloud computing resources).

The retirement financial institution computing system 102 may include one or more processors 120. The processor 120 may include any suitable number of processors and/or processor types, such as CPUs and/or one or more graphics processing units (GPUs). Generally, the processor 120 is configured to execute software instructions stored in a memory 122. The retirement financial institution system 102 may further include a network interface controller (NIC) 124 that may include any suitable network interface controller(s), such as wired/wireless controllers (e.g., Ethernet controllers). The NIC 124 facilitates bidirectional/multiplexed networking over the network 114 between the retirement financial institution computing system 102 and other components of the environment 100 (e.g., the user device 104, the third-party financial institution computing system 106, and the nodes 108 and 110). The modules stored in the memory 122 of the pharmacy management system 102 may include respective sets of computer-executable instructions for performing specific functions (e.g., one or more software libraries). The memory 122 may include one or more persistent memories (e.g., a hard drive/solid state memory) and stores one or more sets of computer executable instructions/modules, including a machine learning (ML) module 130 and a copy of the distributed ledger 116.

The ML module 130 may perform functions related to NFT generation and management, as well as asset management such classification of data and/or generation of recommendations for maximizing asset value, allocating assets, and identifying and generating suggestions to improve data security. In various embodiments, the implemented ML methods and algorithms are directed toward one or more categorizations of ML, including supervised learning, unsupervised learning, and/or reinforcement learning.

The user computing device 104, also referred to herein as a “user computing device,” may be any suitable device, such as a smart phone, a tablet, a desktop computer, etc. The user device 104 may include one or more processors and a memory (not depicted). The one or more processors of user device 104 may include one or more central processing units (CPUs) and/or graphics processing units (GPUs). The processor may be connected to a memory in order to execute software instructions stored in the memory to implement the methods as described herein.

The user device 104 may include an input component 140 and an output component 142 that allow the user to provide input to and perceive outputs of the user device 104. The input component may include a keyboard or a microphone. The output component may be a display and may include any suitable display technology (e.g., LED, OLED, LCD, etc.) for displaying information. In some implementations, the input component 140 and output component 142 may be integrated (e.g., in a touchscreen display) or may be separate. A user may use the input component 140 to enter information and the output component 142 to display information (e.g., financial information, beneficiary information), and to perform other functions.

The user device 104 may be communicatively coupled to other components in the environment 100 (e.g., the retirement financial institution computing system 102, third party financial institutions 106, and/or the nodes 108 and 110) via the network 112. In some implementations, the user device 104 may be configured as a node of the distributed ledger 116. While FIG. 1 depicts one user device 104, any number of user devices 104 may be included in the environment 100, according to some embodiments.

The third-party financial institution computing system 106 may be an individual server, a group (e.g., cluster) of multiple servers, or another suitable type of computing device or system (e.g., a collection of cloud computing resources). The third-party financial institution computing system 106 may be associated with (e.g., owned/operated by) a company that offers financial products and/or services, and/or may be associated with an entity that offers financial products and/or services, including banks, credit unions, brokerage firms, etc. The retirement financial institution computing system 102 may, via the electronic network 112, transmit messages to and receive messages from one or more third-party financial institution computing systems 106 associated with different financial institutions.

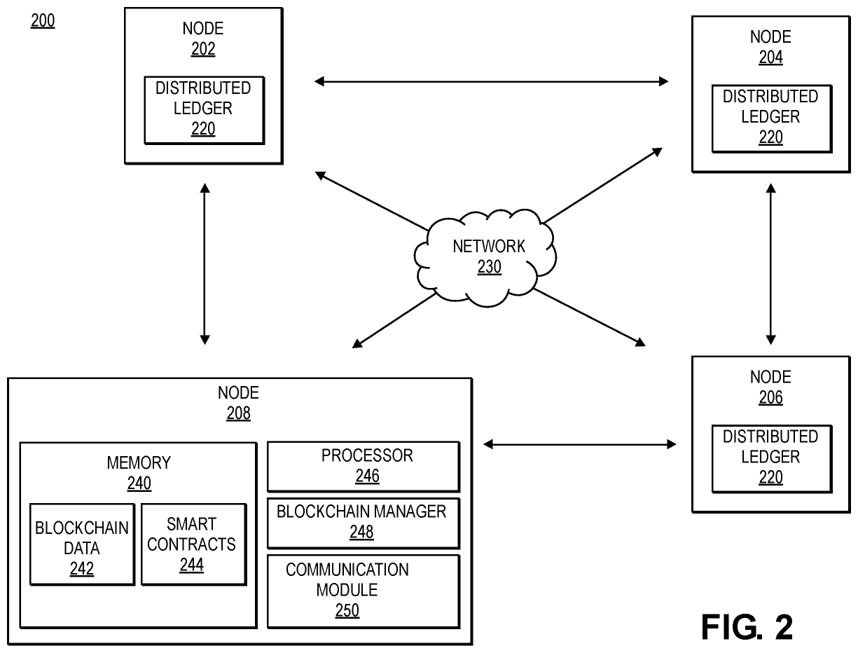

The nodes 108 and 110 may each include a combination of hardware and software components. Node 110 may include similar components as the node 108. As depicted in FIG. 1, the node 108 may include one or more processors 150 and a memory 152, as well as other components not depicted. The memory 152 may maintain a copy of the distributed ledger 116. Other components of the nodes in the system are described in further detail in FIG. 2.

The network 112 may be a single communication network, or may include multiple communication networks of one or more types (e.g., one or more wired and/or wireless local area networks (LANs), and/or one or more wired and/or wireless wide area networks (WANs) such as the Internet). The network 112 may enable bidirectional communication between the retirement financial institution computing system 102, the user device 104, the third party systems 106, the and the nodes 108 and 110.

The distributed ledger 116 may maintain records of NFTs and/or smart contracts for managing retirement benefits. The distributed ledger 116 may be maintained by a plurality of nodes, such as the nodes 108 and 110. In some implementations, the distributed ledger may be a private blockchain or federated blockchain in which the nodes are restricted to a particular group of participants (e.g., nodes associated with the retirement financial institution). The nodes 108 and 110 may be a combination of hardware and software components. The nodes 108 and 110 may each include a respective memory, respective one or more processors, and respective other components. In some aspects, the retirement financial institution computing system 102 may itself be configured as a node or include nodes maintaining the distributed ledger.

The distributed ledger 116 may maintain records of NFTs and/or smart contracts associated with the NFTs for managing retirement benefits. The distributed ledger may be maintained by a plurality of nodes such as the nodes 108 and 110. The distributed ledger 116 may be a federated blockchain and may only be available to nodes with permission to access the blockchain. The retirement financial institution computing system 102 may coordinate with one or more third-party financial institution computing systems 106 to control access to the ledger. The retirement financial institution 102 and/or third-party financial institution computing system 106 may request about the nodes' identity and/or other information, and authenticate and verify such information before granting the nodes permission to join the private blockchain. The retirement financial institution 102 and third-party financial institution 106 may also designate validator nodes to validate transactions.

In operation, a user (e.g., a retiree) may interact with a user device 104 to open an account and submit information such as personal data and/or information about his or her retirement assets to the retirement financial institution computing system 102. The user may also submit information about beneficiaries such as beneficiary personal data and/or an asset distribution scheme associated with the beneficiary and an asset using user device 104. The information may be transmitted to the retirement financial institution computing system 102 via a network 112. The retirement financial institution computing system 102 may retrieve data associated with the one or more retirement assets (e.g., account position, number of shares, balances, etc.) from third party financial systems 106. The retirement financial computing system 102 may utilize an API to retrieve such data. The retirement financial institution 102 may generate one or more tokens representing the one or more retirement assets and beneficiary data associated with one or more retirement assets such that the data associated with the assets is recorded on a distributed ledger 116 maintained by the nodes 108 and 110, which each maintain a copy of the distributed ledger 116. When the retirement financial institution identifies an event triggering the distribution of assets, such as the death of a user, the smart contracts recorded in the distributed ledger automatically execute and distribute assets to receiving parties, such as beneficiaries.

### Exemplary Distributed Ledgers for Implementing a Retirement Asset NFT

FIG. 2 depicts an exemplary distributed ledger system 200 for implementing a retirement asset NFT. The system 200 may include a distributed ledger 220 and a plurality of nodes 202, 204, 206, and 208. Although FIG. 2 depicts only nodes 202, 204, 206, and 208, there may be any suitable number of nodes maintaining the distributed ledger 116.

For a retirement benefit NFT, the distributed ledger 116 may be a federated or consortium blockchain. Retirement financial institution computing system 102 and one or more third party financial institution computing systems 106 may work together to control access to the ledger and decide which nodes can validate transactions. The retirement financial institution computing system 102 and the one or more third party financial institution computing systems 106 together may grant the nodes 202, 204, 206, and 208 explicit permission to join and contribute to the blockchain. In some aspects, the distributed ledger 116 may be a private blockchain controlled by a retirement financial institution. The retirement financial institution computing system 102 and third-party financial institution computing system 106 may act as a authorities controlling access to the ledger, and may grant the nodes 202, 204, 206, and 208 explicit permission to join and contribute to the blockchain.

Each of the nodes 202, 204, 206, and 208 maintains a copy of the distributed ledger 220. As changes are made to the distributed ledger 220, each node receives the change via network 230 and updates its respective copy of the distributed ledger 220. A consensus mechanism may be used by the nodes 202, 204, 206, and 208 to decide whether it is appropriate to make received changes to the distributed ledger 220. By maintaining a consensus among the nodes 202, 204, 206, and 208 to authorize any updates or changes to the distributed ledger 220, each node may have an identical copy of the distributed ledger 220 as stored by the other nodes. As the distributed ledger has a decentralized nature, there is no single point of failure as there is in conventional centralized systems. The distributed ledger system 200 may therefore be more robust than a central authority database system. A federated blockchain like one used to record retirement benefit NFTs may also have this decentralized nature. Thus, record-keeping of retirement benefit NFTs will be kept secure as the system will not have a single point of failure. Moreover, the federated blockchain will add more security, as it will only be open to nodes that have been approved by the retirement financial institution 102 and the third-party financial institution 106. The records of the retirement assets will be safeguarded from erroneous and/or malicious changes due to the restriction of participants and the decentralized nature of the blockchain.

The node 208 depicts exemplary components of a node maintaining distributed ledger 220 on which a retirement benefit NFT is recorded. The nodes 202, 204, and 206 may contain similar components as the node 208 and may behave similarly to the node 208. The node 208 may include one or more processors 246, a memory 240, a blockchain manager 248, and a communication module 250. The node 208 may have additional or fewer components than described.

The node 208 may generate a new block of transactions and/or may broadcast transactions to other nodes (e.g., the nodes 202, 204, and 206) by using the blockchain manager 248. The memory 240 may include a blockchain data set 242 and a smart contracts set 244. The blockchain data 242 may be included in a state database of the distributed ledger 220 for storing states of smart contracts deployed thereon. The blockchain manager 248 may reference the blockchain data 242 when broadcasting transactions to other nodes. The node 208 may use the blockchain manager 248 in conjunction with the processor 246 and smart contracts 244 to execute some of the functionality related to generating and/or executing transactions for recordation in the distributed ledger. In some embodiments, the smart contracts 244 may operate independently of the blockchain manager 248. The smart contracts 244 may automatically execute in response to a triggering condition such that the processor 246 does not interact with the blockchain manger 248 when the triggering condition is satisfied. For example, the trigger may be a verification of the user's death, or the user reaching an age requiring a distribution of funds. In some aspects, oracles may feed external data, such as a death record, to the blockchain to trigger execution of smart contracts. In response to the trigger, the smart contracts may automatically execute to distribute funds accordingly. For example, when a notification of the user's death has been verified, the user's assets are automatically distributed to beneficiaries according to the distribution scheme encoded in smart contracts.

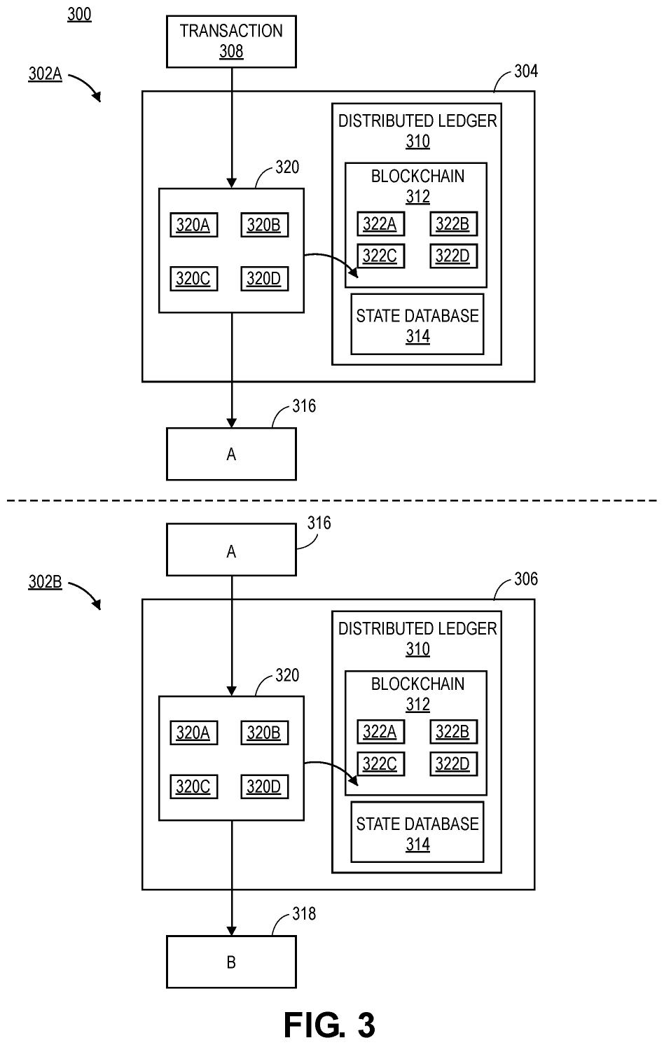

FIG. 3 depicts a block flow diagram of exemplary nodes and an exemplary transaction flow 300 on a distributed ledger network for implementing an NFT of a retirement asset. FIG. 3 includes two timeframes 302A and 302B, a node 304, a node 306, a set of transactions 320A-320D, a set of blocks of transactions 322A-322D, a distributed ledger 310, a blockchain 312, and a state database 314. The distributed ledger 116 of FIG. 1 may implement the techniques of recording transactions as described below, where the distributed ledger 116 of FIG. 1 is similar to the distributed ledger 310, and the nodes 108 and 110 are configured and behave similarly to nodes 304 and 306.

The flow 300 may begin at time 302 when the node 306 receives a transaction 308. For example, the transaction in a system for managing retirement benefits may be the minting of an NFT representing a user's asset. The node 304 confirms that the transaction 308 is valid and adds the transaction to a newly generated block 320. To add transaction 308 to block 320, proof of work may be used, in which the node 304 may solve a cryptographic puzzle and include the solution in the block 320 as proof of the work done to generate block 320. Alternatively, a proof of stake algorithm may be used to generate block 320, in which the node 308 stakes an amount of digital token used on the network, and the network determines the node 308 will mint the new block. Alternatively, a proof of authority algorithm may be used to generate block 320, in which transactions and blocks are validated by validators (i.e., approved accounts) that run software allowing them to record transactions in the distributed ledger. Validators may be approved by an authority such as the retirement financial institution computing system 102.

While proof of work, proof of stake, and/or proof of authority are described herein as consensus algorithms for selecting a node to mint a new distributed ledger entry (e.g., newly generated block 308), these are merely a few example consensus algorithms and are not intended to be limiting. Additional consensus algorithms may be utilized. For example, delegated proof of stake algorithm may be used, in which nodes elect a subset of nodes referred to as delegates to perform validation, and the delegates take turns minting new distributed ledger entries. Other consensus algorithms may include proof of weight, Byzantine fault tolerance such as practical and federated Byzantine fault tolerance, tangle consensus algorithms, block lattice consensus algorithms, etc. Additionally, quorum slices may be selected, in which a quorum is a set of nodes that participate in the consensus protocol and a quorum slice is its subset that helps a node in its agreement process. Individual trust decisions may be made by participants in the distributed ledger network to construct a quorum slice. Still further, security circles may be identified, which are closed groups of network participants who together can form a quorum to reach a consensus on a transaction and to make further trust decisions.

The transaction 308 may mint an NFT that is associated with a retirement asset, such as a bank account, pension account, 401k, 403b, an individual retirement account (IRA), a simplified employee pension (SEP) IRA, a SIMPLE IRA, a health savings account (HAS), a flexible spending account (FSA), etc. In another example, the NFT may be a commemorative NFT associated with life events of the user. The NFT may include and/or otherwise reference a digital image, a digital audio file, a digital video file, or any other suitable representation or combination thereof. For example, a commemorative NFT may include an image of the user and text describing the user.

In some embodiments, transaction 308 may be added to a pool of transactions until a sufficient number of transactions in the pool exist to form a block or distributed ledger entry. The node 304 may transmit the newly created distributed ledger entry 308 to the network at time 316.

The transactions 322A-322D may include updates to a state database 314. The state database 314 may contain current values of variables created by smart contracts on blockchain 312. Validated distributed ledger entries, such as the block 320, may include transactions affecting state variables in state database 314.

At timeframe 302B, the node 306 may receive distributed ledger entry 308 via the network. The node 306 may validate distributed ledger entry 308 by checking the solution to the cryptographic puzzle provided in the distributed ledger entry 308. If the solution is accurate, the node 306 may add the distributed ledger entry 308 to its blockchain 312 and make any updates to the state database 314 as rejected by the transactions in distributed ledger entry 308. The node 306 may then transmit the distributed ledger entry 308 to the rest of the network at time 318.

### Exemplary Tokenization of Retirement Assets

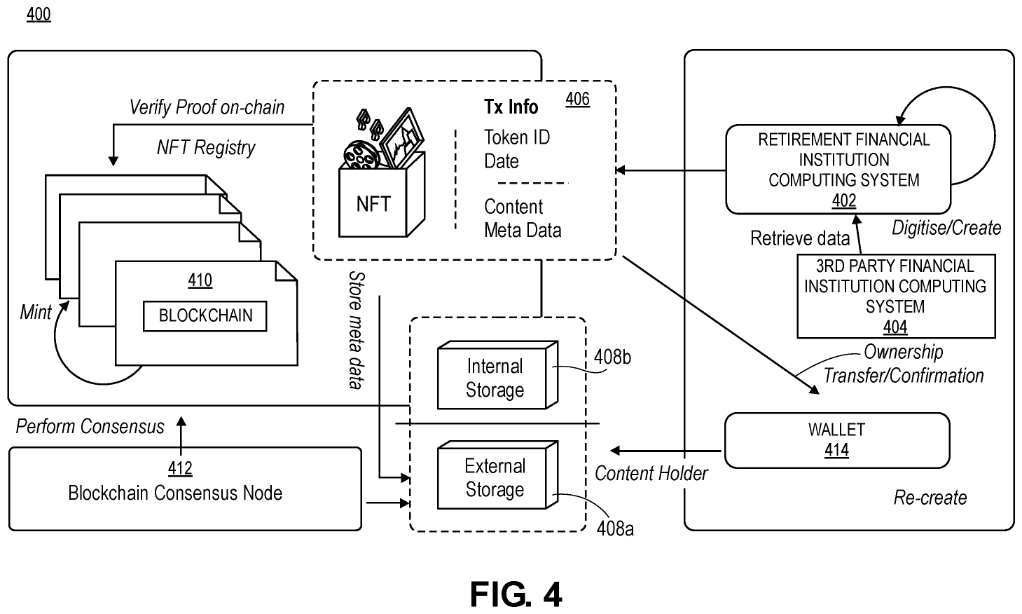

FIG. 4 depicts an example combined block and flow diagram of a system for tokenizing retirement assets.

For example, a retirement asset may be a bank account, pension account, 401k, 403b, an IRA, a SEP IRA, a SIMPLE IRA, an HSA, an FSA, etc.

The retirement financial institution computing system 402 may retrieve, from a third party financial institution computing system 404, data associated with an asset to tokenize the asset. The retirement asset data may include a type of asset, the name of the financial institution at which the asset is located, the value of the asset, etc. The retirement financial institution computing system 402 may properly format the data according to a standard, such as ERC-721, as the NFT's metadata. The metadata may include a name, a description, traits, etc. In some aspects, the metadata may also include or reference a digital image file, a digital audio file, a digital video file, etc. For example, the metadata of a commemorative NFT may reference a digital image file depicting the retiree. In some aspects, the retirement financial institution computing system 402 may use machine learning to identify traits of the asset (e.g., asset type, financial institution at which the asset is located, etc.), to include in the metadata. In some aspects, some or all of the metadata of NFT 406 may be stored in external (i.e., off-chain) storage 408a (e.g., InterPlanetary File System (IPFS)), while some metadata and the NFT's unique ID is stored in internal (i.e., on-chain) storage 408b. For example, metadata related to transactions and the identity of the financial institution holding the asset may be included in internal storage 408b. In some aspects, the entirety of NFT 406 may be stored in internal (i.e., on-chain) storage 408b. The retirement financial computing system 402 broadcasts the retirement asset data to the blockchain 410 to trigger a smart contract function that creates a unique token 406. A blockchain consensus node 412 may use a consensus algorithm to validate the token 406 to be added to the blockchain. The token is stored on the blockchain and points to the location where the NFT metadata is stored. In some aspects, the retirement financial institution computing system 402 may use an API to interact with an external asset tokenization program to assist in tokenizing the assets.

After the NFT has been minted, it may be transferred to a digital wallet 414 associated with an account holder who owns the asset. The account holder may access the wallet 414 via a user device. The digital wallet may include a pair of cryptographically linked keys: a private key, which is used by the owner of a wallet to authorize transactions and prove ownership of blockchain assets, and a public key, which acts as an address so that others may transfer assets to the wallet. A smart contract on the blockchain may self-execute to transfer the NFT to the wallet 414 and record the transaction on the blockchain. In some aspects, a distribution event may cause the NFT to be transferred to another wallet. For example, the death of the retiree may trigger smart contracts to automatically execute a transfer of the NFT from the digital wallet 414 to a digital wallet associated with a beneficiary. A smart contract may execute to transfer the NFT from the digital wallet 414 to a digital wallet associated with a beneficiary. The smart contract code may first check the address of the digital wallet 414 to confirm the retiree actually owned the NFT that is to be transferred, and then record the address (hashed version of the public key) of the beneficiary wallet as the owner of the NFT on the blockchain after the transaction has been validated.

An NFT representing a retirement asset may also be fractionalized. For example, a retiree may designate multiple beneficiaries for one account. The NFT smart contract may include information to split the NFT into multiple fungible tokens as needed based on the number of beneficiaries listed for the account.

Distribution events other than death may exist. For example, a retiree may wish to take out a loan. An NFT smart contract may execute to fractionalize the NFT and split the NFT into fungible tokens to be granted to lender. Once the loan has been repaid, the original NFT may be reconstituted from the fractionalized tokens transferred back to the account holder. In another example, different types of accounts may include different rules, which the retirement financial institution computing system 404 encodes in smart contracts, for distribution. For example, traditional IRA and 401 (k) accounts have required minimum distributions (RMDs) that are mandatory withdrawals that an account holder must take once he or she reaches a certain age. The RMD amount depends on the size of the account and the account holder's life expectancy. The smart contracts may automatically execute to follow these rules and distribute the correct RMD to the account holder. In some aspects, the retirement financial institution computing system 402 receives such information from an account holder submitting instructions for distribution. In some aspects, the instructions may be parsed using natural language processing and/or semantic analysis from supporting documents such as a will or trust document. In some aspects, distributions, such as an RMD, may occur periodically over time according to the distribution scheme. In some implementations, changes to a retiree's asset may require a retokenization of the asset. For example, if the retiree rebalances his or her account, the account may need to be retokenized to accurately reflect the changes in the account.

A retiree may transfer a retirement asset from one third-party financial institution 404 to another third-party financial institution, or to the retirement financial institution 402. In some implementations, the asset may be retokenized to reflect such a change. In other implementations, a smart contract may be executed to update metadata indicating an identification of the institution holding the asset.

### Exemplary User Interface

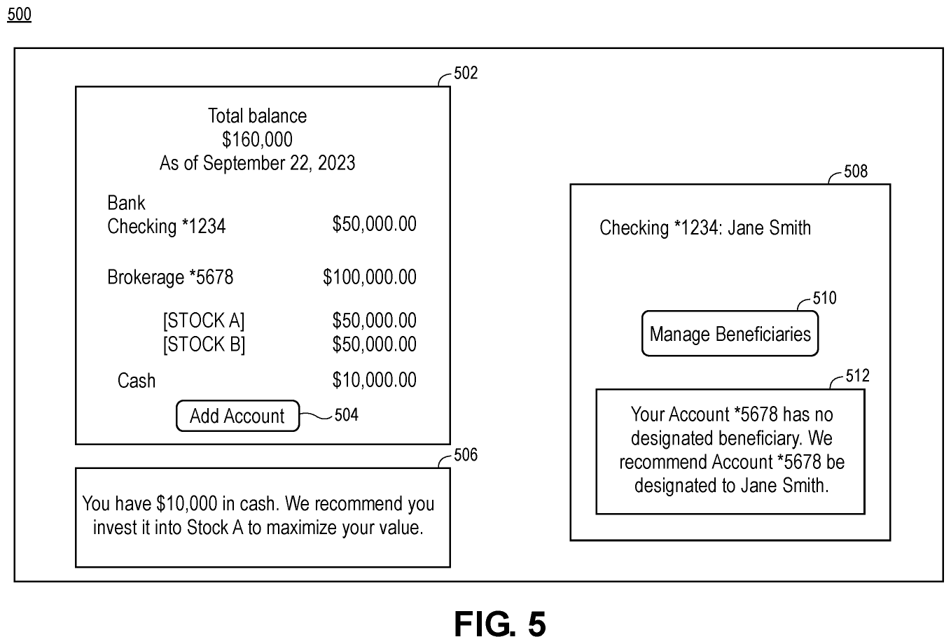

FIG. 5 is an exemplary user interface of an application for managing retirement benefits. The application may be a mobile, desktop, or web application. The user interface may be displayed on an output component such as output component 142 of a user device 104 as shown in FIG. 1.

The user interface 500 may be a dashboard displays information about the user's retirement account and may include an assets summary 502, a financial suggestions section 506, and a beneficiary section 508.

The assets summary 502 provides a listing of the user's assets. A user may have multiple assets at different financial institutions, such as banks, credit unions, investment banks, etc. In some implementations, the user may transmit personal identification information to a retirement financial institution computing system such as the retirement financial computing system 102. The user may submit such information by interacting with an input device of a user device, such as the input device 140 of a user device 104 as depicted in FIG. 1, to enter the information into an application, which is then submitted to the retirement financial computing system via a network such as network 112 of FIG. 1.

The retirement financial computing system 102 and automatically searches for any assets associated with that personal identification information via network 112. Additionally or alternatively, the user may submit specific asset identification information (e.g., the name of a third-party financial institution, a routing number, an account number, etc.) to the retirement financial computing system 102. In some implementations, users may also provide their investment strategies. In some implementations, the user may enter this information during a retirement account setup (not depicted). Additionally or alternatively, the user may interact with an “Add Account” icon 454 in the user interface 500. The retirement financial computing system 102 retrieves asset data (e.g., balance, position) from third-party financial institutions via an API, which may be displayed in an asset summary pane 402 (“Checking*1234 $50,000,” “Brokerage*5678 $100,000,” “Cash $10,000”). In some implementations, the summary pane 402 may include additional detailed information, such as the monetary value of an asset or a number of shares. For example, in FIG. 5, the value of the different stocks (“Stock A $50,000,” “Stock B $50,000”) is displayed.

In some implementations, the summary pane 502 may display a consolidation and value of accounts by account type. For example, an account may be a checking account, savings account, an IRA, a SEP IRA, a SIMPLE IRA, a 401 (k) account, a 403 (b) account, an HSA, an FSA, etc. In some implementations, the retirement financial system 102 may use ML algorithms to classify a user's assets into a type of asset. For example, a user may have multiple checking accounts at the same institution and/or across multiple institutions. The retirement financial system 102 may use ML algorithms to categorize these accounts into a type of account (checking) and the total value of such accounts to be displayed in the summary pane 402, instead of or in addition to individual accounts and values of FIG. 5. The summary pane 402 may also display a total account value (“Total balance $160,000”), which may be calculated by the retirement financial institution computing system 102. The summary pane 402 may also display a date (“Sep. 22, 2023”). The date may be the date that the user accesses the retirement account. In some implementations, the user may be able to view historical data of the account over time or for a specific date.

The user interface may also include a financial suggestions section 506. The financial suggestions pane 506 displays suggestions for maximizing the value of the retirement account. The retirement financial institution computing system 102 may access market data (e.g., stock market data) via an API to make suggestions. The retirement financial institution computing system 102 may utilize machine learning algorithms to generate suggestions for maximizing account value. ML models may be trained on historical market data and may use one or more of the distribution scheme, the beneficiary data, the one or more assets, and the market data to generate suggestions. For example, the retirement financial institution computing system 102 may use unsupervised learning to generate recommendations to maximize account value. The retirement financial institution computing system 102 may be provided with example inputs of historical market data to identify economic trends and generate recommendations based on those trends. For example, the retirement financial institution computing system 102 may identify particular types of stocks to invest in based on trends in market data. In another example, the retirement financial institution computing system 102 may use supervised learning to generate recommendations. The retirement financial institution computing system 102 may be provided with example inputs, such as examples of retirement accounts with different portfolios of assets, and associated outputs, such as actions taken with respect to the accounts in order to discover a general rule that maps inputs to outputs. When subsequent novel inputs, such as a real account holder's actual account, is provided to the retirement financial institution computing system 102, the retirement financial institution computing system 102 may accurately predict a correct or preferred output. For example, as shown in FIG. 5, the account holder has $10,000 in cash, as shown in summary pane 502 (“Cash $10,000”) and in financial suggestions pane 506 (“You have $10,000 in cash.”). The financial suggestions pane 506 recommends the account holder take action with regards to the cash (“We recommend you invest it into Stock A to maximize your value.”). This recommendation may be the result of supervised learning, in which the example input would be accounts with uninvested cash, and the associated output would be investing the cash such that, when presented with account holder's account, the retirement financial institution computing system 102 recommends the user to invest the $10,000 cash. In some implementations, the retirement financial institution computing system 102 may utilize a chatbot or voice bot to communicate suggestions to users in a conversational format.

The user interface may also include a beneficiary section 508. The beneficiary pane 508 may display user assets (“Checking*1234”), one or more beneficiaries of the assets (“Jane Smith”), and a distribution scheme for the assets (“100%”). The user may submit beneficiary information (e.g., name, address, relationship to the user, birthday, social security number, distribution scheme) to the retirement financial institution computing system 102. In some implementations, the distribution scheme may include information on whether a beneficiary is a primary or contingent beneficiary (i.e., a beneficiary that takes the primary beneficiary's place if the primary beneficiary is deceased or unresponsive), supporting documents (e.g., wills, trusts, power of attorney authorizations), and/or conditional rules (e.g., percentages, specified amounts, timing of distribution). The user may transmit such information by interacting with an input device 140 of a user device 104 to submit the information to the retirement financial computing system via network 112. In some implementations, the user may enter beneficiary information during an account setup phase. In some implementations, the user may interact with a “Manage Beneficiaries” icon 410 in the user interface to add beneficiaries, remove beneficiaries, or modify the beneficiary data or distribution scheme.

The user interface may also include a beneficiary suggestions section 512. The beneficiary suggestions section 512 may display suggestions for beneficiaries. The retirement financial institution computing system 102 may utilize machine learning algorithms to generate suggestions for allocating assets to beneficiaries. The retirement financial institution computing system 102 may identify unallocated assets and generate suggestions for distributing assets (“We recommend account*5678 be designated to Jane Smith.”). For example, the retirement financial institution computing system 102 may use supervised machine learning to generate the suggestion, where the retirement financial institution computing system 102 is provided with example accounts as the inputs and outputs where existing beneficiaries are named as beneficiaries of previously unallocated assets. In some implementations, the retirement financial institution 102 may be trained on default rules to encode a distribution scheme. For example, for assets that have no designated beneficiary, the retirement financial institution 102 may make suggestions for beneficiaries based on the intestacy law of the state in which the account holder resides. The retirement financial computing system 102 may also generate suggestions to optimize the allocation of assets. In some implementations, the retirement financial institution computing system 102 may utilize a chatbot or voice bot provide suggestions in a conversational format.

Exemplary Methods for Managing Retirement Benefits with NFTs

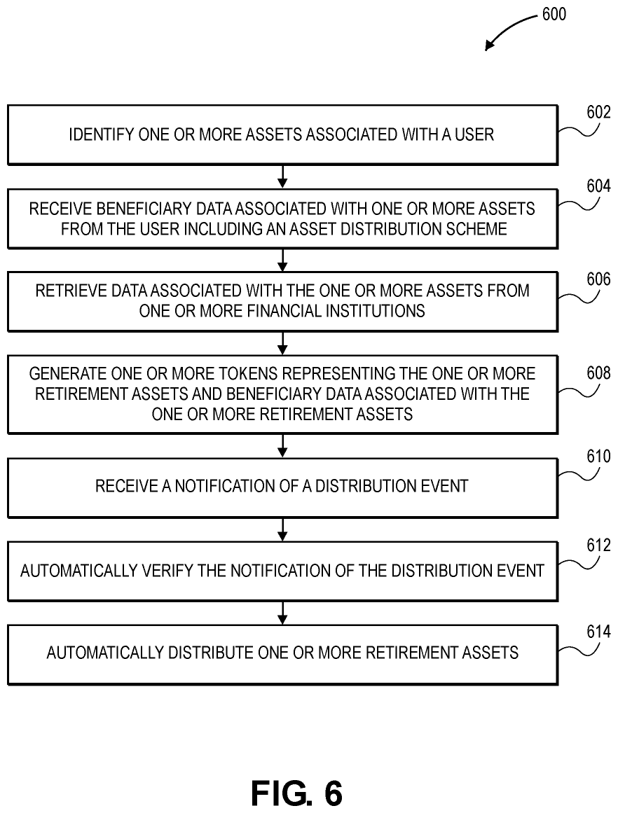

FIG. 6 depicts a flow diagram of an example method for managing retirement benefits with NFTs. One or more steps of the computer-implemented method of 600 may be implemented as a set of instructions stored on a computer-readable memory and executable on one or more processors. The computer-implemented method 600 may operate in the environment illustrated in FIG. 1.

At block 602, a retirement financial institution computing system such as the retirement financial institution computing system 102 of FIG. 1 may identify one or more assets associated with a user (i.e., a retiree). A user may own one or more assets across various third-party institutions. The assets may include pension funds, stocks, bonds, mutual funds, real property, an individual retirement account, a 401 (k) account, a 403 (b) account, a health savings account, a flexible spending account, etc. In some implementations, the user may submit this information during an initial setup of a retirement account. The user may submit this information interacting with an input device 140 of a user device 104 to enter the information into an application associated with the retirement financial institution 102.

At block 604, the retirement financial institution computing system 102 may receive beneficiary data associated with the one or more assets from the user. The beneficiary data includes personal data of the beneficiary (e.g., name, address, date of birth, social security number, relation to the retiree, etc.) and an asset distribution scheme. In some implementations, the user may submit the beneficiary data by inputting the information into the user device 104 by using the input device 140 of the user device 104. In some implementations, the user may submit all of the beneficiary data to the retirement financial institution computing system 102. In some implementations, the beneficiary data, such as the asset distribution scheme, may be partially or completely arranged using machine learning. In some implementations, the retirement financial institution computing system 102 may utilize machine learning algorithms to identify one or more user assets that have not been allocated in the asset distribution scheme, and generate recommendations for allocating the one or more assets to one or more beneficiaries in the asset distribution scheme. For example, the retirement financial institution computing system 102 may identify stock that has no listed beneficiary. The retirement financial institution computing system 102 may recommend that the stock be split among the beneficiaries of the user's other assets.

At block 606, the retirement financial institution computing system 102 may retrieve data associated with the one or more assets from one or more financial institutions. The retirement financial institution computing system 102 may retrieve the data from one or more third-party financial institutions via an API. The API may be implemented as an endpoint accessible via a web service protocol, such as representational state transfer (REST), Simple Object Access Protocol (SOAP), JavaScript Object Notation (JSON), etc. The API may require authentication. For example, the API may require one or more API keys in order for the retirement financial institution to call an API to retrieve information from a third-party financial institution. In some implementations, the retirement financial institution may also require authorization.

In some implementations, the retirement financial institution computing system 102 may receive market data (e.g., stock prices, value of foreign currency, news, government notices). The retirement financial institution computing system 102 may use at least one of the asset distribution scheme, beneficiary data, the one or more assets, and the market data to generate recommendations for maximizing the value of one or more assets. The retirement financial institution computing system 102 may use a machine learning model to generate the recommendations. For example, the machine learning model may identify that the user has received a cash dividend and recommend that the user reinvest the dividend into buying more shares of the same investment.

At block 608, the retirement financial institution computing system 102 may mint one or more tokens representing the one or more retirement assets and beneficiary data associated with the one or more retirement assets. In some implementations, the retirement financial computing system 102 may utilize an external asset tokenization platform via an API. The token may be an NFT that may or may not have inherent marketable value. In some implementations, artificial intelligence and machine learning techniques are used to improve recordation of the data by identifying and classifying the type of asset and data associated with the asset. The beneficiary data includes an asset distribution scheme with instructions on distributing the user's assets to beneficiaries upon the user's death. The asset distribution scheme is encoded as one or more smart contracts. In some aspects, the retirement financial institution computing system 102 may rely on supporting documents, such as a will, to encode the distribution scheme.

In some implementations, the retirement financial institution computing system 102 may identify a change in the one or more assets. The retirement financial institution computing system 102 may utilize a machine learning model to identify which types of assets and asset data require frequent or infrequent updates, and which types of asset and asset data should be more heavily monitored for updates. The machine learning model may evaluate the quality of the data associated with an asset and/or determine if a change in the one or more assets requires the asset to be retokenized. For example, the retirement financial institution computing system 102 may use supervised learning to determine whether asset should be retokenized, where the retirement financial institution computing system 102 is provided with example inputs of some situations requiring tokenization and some situations that do not require retokenization, and the associated output showing the correct action for each example input. If the retirement financial institution computing system 102 determines that an asset needs to be retokenized, the retirement financial computing system retokenizes that asset. For example, a dividend reinvestment of shares of a particular corporation would require retokenization of the asset. Not all changes to assets may require retokenization.

At block 610, the retirement financial institution computing system 102 receives a notification of a distribution event associated with one or more retirement assets. The distribution event triggers distribution of assets and may include death of the user, a required minimum distribution, an early distribution, and/or a loan. An account holder may submit the notification of the distribution event. For example, the account holder may transfer funds to another account. In some aspects, a beneficiary or family member of the user may submit the notification. For example, when an account holder dies, a beneficiary or family member may notify the retirement financial institution computing system 102. In another aspect, the retirement financial institution computing system 102 may retrieve public information from other sources, such as the internet, that indicate a distribution event. For example, the retirement financial institution computing system 102 may retrieve information regarding the current date and the account holder's birthday to determine that an RMD is necessary.

At block 612, the retirement financial institution computing system 102 automatically verifies the notification of the event associated with distribution. The retirement financial institution computing system 102 may verify the notification by retrieving information (e.g., a death certificate) from a third-party database, a government database, and/or from a beneficiary or family member of the user. The retirement financial institution computing system may also initiate communications (e.g., phone call, email) with the account holder, one or more beneficiaries, or family members to verify the occurrence of the distribution event.

At block 614, the retirement financial institution computing system 102 automatically distributes one or more retirement assets via the smart contracts. The retirement financial institution computing system 102 unblocks the assets so that they may be distributed to the one or more beneficiaries.

In some implementations, the retirement financial institution computing system 102 may receive life event data associated with the user. A commemorative NFT for beneficiaries including the data may be minted on the distributed ledger. The life event data may include one or more of images, text, audio, video, etc. In some implementations, the user may submit the life event data by inputting the information into the user device 104 by using the input device 140 of the user device 104. In some implementations members of the public who know the NFT ID may contribute to the NFT while one or more family members and/or beneficiaries moderate the contributions. In other implementations, beneficiaries may submit life event data of the user the retirement financial computing system 102.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

In addition, various machine learning methods and algorithms may be used to implement the techniques disclosed herein, such as linear or logistic regression, instance-based algorithms, regularization algorithms, decision trees, Bayesian networks, cluster analysis, association rule learning, artificial neural networks, deep learning, combined learning, reinforced learning, dimensionality reduction, and/or support vector machines. In various embodiments, the implemented ML methods and algorithms are directed toward one or more categorizations of ML, including supervised learning, unsupervised learning, and/or reinforcement learning.

Upon reading this disclosure, those of ordinary skill in the art will appreciate still additional alternative structural and functional designs for implementing the techniques disclosed herein through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A computer system for generating and facilitating an exchange of one or more non-fungible tokens, the system comprising:
one or more processors; and
one or more memories having stored thereon instructions that, when executed cause the one or more processors to:
identify one or more retirement assets associated with a user;
receive beneficiary data associated with the one or more retirement assets from the user, the beneficiary data including an asset distribution scheme;
retrieve data associated with the one or more retirement assets from one or more financial institutions via an application programming interface;
generate one or more non-fungible tokens representing the one or more retirement assets and beneficiary data associated with the one or more retirement assets by minting the one or more non-fungible tokens;
receive a notification of a distribution event associated with the one or more retirement assets;
verify the notification of the distribution event; and
distribute one or more retirement assets via one or more smart contracts.

2. The computer system of claim 1, wherein the distribution event includes at least one of: (i) death of the user; (ii) a required minimum distribution; (iii) an early distribution; and (iv) a loan.

3. The computer system of claim 1, the one or more memories having stored thereon further instructions that, when executed by the one or more processors, cause the processors to:
identify a change in one or more assets;
determine a need to retokenize one or more non-fungible tokens representing the one or more assets using a machine learning model; and
retokenize the one or more assets.

4. The computer system of claim 1, the one or more memories having stored thereon further instructions that, when executed by the one or more processors, cause the one or more processors to:
receive market data;
generate, using a machine learning model, recommendations for maximizing a value of the one or more retirement assets based on at least one of: (i) the asset distribution scheme, (ii) the beneficiary data, (iii) the one or more assets, and (iv) the market data.

5. The computer system of claim 1, the one or more memories having stored thereon further instructions that, when executed by the one or more processors, cause the one or more processors to:
identify one or more unallocated assets; and
generate, using a machine learning model, recommendations for allocating the one or more unallocated assets to one or more beneficiaries in the asset distribution scheme.

5. (canceled)

6. The computer system of claim 1, the one or more memories having stored thereon further instructions that, when executed by the one or more processors, cause the one or more processors to:
receive life event data associated with the user; and
mint a token representing the life event data.

7. The computer system of claim 1, wherein the one or more assets includes at least one of: (i) a pension account; (ii) a bank account; (iii) a brokerage account; (iv) real property; (v) a stock; (vi) a bond, (vii) an individual retirement account, (viii) a 401 (k) account; (ix) a 403 (b) account; (x) a health savings account; and (xi) a flexible spending account.

8. A computer-implemented method for generating and facilitating an exchange of one or more non-fungible tokens, the method comprising:
identifying, via one or more processors, one or more retirement assets associated with a user;
receiving, via the one or more processors, beneficiary data associated with the one or more retirement assets from the user, the beneficiary data including an asset distribution scheme;
retrieving, via the one or more processors, data associated with the one or more retirement assets from one or more financial institutions via an application programming interface;
generating, via the one or more processors, one or more tokens representing one or more retirement assets and beneficiary data associated with the one or more retirement assets, the asset distribution scheme encoded as one or more smart contracts;
receiving, via the one or more processors, a notification of a distribution event associated with the one or more retirement assets;
verifying, via the one or more processors, the notification of the distribution event; and
distributing, via the one or more processors, one or more retirement assets via the one or more smart contracts.

9. The computer-implemented method of claim 8, wherein the distribution event includes at least one of: (i) death of the user; (ii) a required minimum distribution; (iii) an early distribution; and (iv) a loan.

10. The computer-implemented method of claim 8, further comprising:
identifying, via one or more processors, a change in one or more assets;
determining, via one or more processors, a need to retokenize one or more tokens representing the one or more assets using a machine learning model; and
retokenizing, via the one or more processors, the one or more assets.

11. The computer-implemented method of claim 8, further comprising:
receiving, via the one or more processors, market data;
generating, via the one or more processors and using a machine learning model, recommendations for maximizing a value of the one or more assets based on at least one of: (i) the distribution scheme, (ii) the beneficiary data, (iii) the one or more assets, and (iv) the market data.

12. The computer-implemented method of claim 8, further comprising:
identifying, via the one or more processors, one or more unallocated assets; and
generating, via the one or more processors and using a machine learning model, recommendations for allocating the one or more unallocated assets to one or more beneficiaries in the asset distribution scheme.

13. The computer-implemented method of claim 8, further comprising:
receiving, via the one or more processors, life event data associated with the user; and
minting, via the one or more processors, a token representing the life event data.

14. The computer-implemented method of claim 8, wherein the one or more assets includes at least one of: (i) a pension account; (ii) a bank account; (iii) a brokerage account; (iv) real property; (v) a stock; (vi) a bond, (vii) an individual retirement account, (viii) a 401 (k) account; (ix) a 403 (b) account; (x) a health savings account; and (xi) a flexible spending account.

15. A non-transitory computer-readable medium having stored thereon program instructions that when executed, cause one or more processors to at least:
identify one or more retirement assets associated with a user;
receive beneficiary data associated with the one or more assets from the user, the beneficiary data including an asset distribution scheme;
retrieve data associated with the one or more assets from one or more financial institutions via an application programming interface;
generate one or more tokens representing the one or more retirement assets and beneficiary data associated with the one or more retirement assets, the asset distribution scheme encoded as one or more smart contracts;
receive a notification of a distribution event associated with the one or more retirement assets;
verify the notification of the distribution event; and
distribute one or more retirement assets via the one or more smart contracts.

16. The non-transitory computer-readable medium of claim 15, wherein the distribution event includes at least one of: (i) death of the user; (ii) a required minimum distribution; (iii) an early distribution; and (iv) a loan.

17. The non-transitory computer-readable medium of claim 15, having stored thereon further instructions that, when executed by one or more processors, cause the processors to:
identify a change in one or more assets;
determine a need to retokenize one or more tokens representing the one or more assets using a machine learning model; and
retokenize the one or more assets.

18. The non-transitory computer-readable medium of claim 15, having stored thereon further instructions that, when executed by one or more processors, cause the processors to:
receive market data;
generate, using a machine learning model, recommendations for maximizing a value of the one or more assets based on at least one of: (i) the distribution scheme, (ii) the beneficiary data, (iii) the one or more assets, and (iv) the market data.

19. The non-transitory computer-readable medium of claim 15, having stored thereon further instructions that, when executed by one or more processors, cause the processors to:
identify one or more unallocated assets; and
generate, using a machine learning model, recommendations for allocating the one or more unallocated assets to one or more beneficiaries in the asset distribution scheme.

20. The non-transitory computer-readable medium of claim 15, having stored thereon further instructions that, when executed by one or more processors, cause the processors to:
receive life event data associated with the user; and
mint a token representing the life event data.
